(19) United States
(12) Patent Application Publication
(10) Pub. No.: US 2012/0207891 A1
(43) Pub. Date: Aug. 16, 2012

(54) Egg Poacher and Method for Poaching

(75) Inventors: Sarah Pantaleo, Sandy Springs, GA (US); Dean Olaya, Atlanta, GA (US)

(73) Assignee: Calphalon Corporation, Atlanta, GA (US)

(21) Appl. No.: 13/028,048

(22) Filed: Feb. 15, 2011

(51) Int. Cl. A47J 29/06; A23L 1/32

(52) U.S. Cl. 426/300; 99/403

(57) ABSTRACT

An egg poacher includes a cup having a bottom, a side wall extending upward from a perimeter of the bottom, an open top at a top edge of the side wall, and a plurality of perforations formed through the side wall but not through the bottom. The egg poacher may have a handle connected to a part of the side wall. The handle may be curved. A method of poaching an egg includes the steps of selecting an egg poacher, placing the egg poacher in a pan of simmering water, cracking open and placing a raw egg contents in the cup, cooking the egg contents, lifting and draining water from the cup, and releasing the cooked egg.

### BACKGROUND

1. Field of the Disclosure

The present disclosure is generally directed to cookware devices, and more particularly to an egg poacher.

2. Description of Related Art

Poaching an egg involves simmering an egg in water. During the traditional poaching process, a raw egg is gently floated in a pan of simmering water. A cook creates a vortex by gently stiffing the water. The slowly swirling water helps to contain the whites of the egg until the cooking process progresses sufficiently that the egg white coagulates and stays together. Milk can be substituted for water for a variation. Some cooks are known to add a dash of white vinegar to the water to aid in coagulating the egg white while cooking.

Poaching an egg in the traditional manner is difficult for a number of reasons. If the water is boiling too vigorously the egg white tends to spread into small bits throughout the cooking water. If the water is stirred to vigorously, the same problem can occur. Further, if a strong enough vortex is not created, the egg white may still tend to spread into the surrounding water. All of these events tend to make a poached egg messy or ragged and hard to remove from the water.

A poached egg is usually removed from the cooking water using a large slotted spoon. Even when cooked cohesively a poached egg can be difficult to remove from the water as the egg tends to be slippery and can slide back into the water. Further, the egg can break while being removed with a spoon.

Others have attempted to solve these problems in various ways. In one example, eggs are cooked in a plurality of cups. The individual cups are placed in a holder. Then, the assembly of holder and cups is positioned in or over boiling water in a manner similar to that of a double boiler. In essence, eggs cooked in such a device are not truly “poached” but are “steamed” because the eggs are not cooked in water. This device and method can result in the eggs being cooked at a higher temperature than the temperature of true poaching. Eggs cooked at such higher temperature have a different character than truly poached eggs.

In another example, an egg ring is used. An egg ring is a ring of a metal such as steel or other material with a handle. The ring is placed in the cooking water and the water is brought to a boil. The raw egg is placed within the ring for cooking. One problem with the ring device and its method of use is that egg white can leach from under or over the ring, again resulting in a messy or ragged poached egg. Another problem with the ring device is that it can be difficult to remove a cooked egg. An egg poached using the ring must still be removed from the water with a spoon or the like because the ring has no bottom.

In another example, eggs are cooked in individual solid egg cups made of plastic, metal, or silicone. An egg is placed in the cup with the water and cooked. However, solid egg cups also pose some disadvantages. The plastic and silicone cups may tend to float and/or tip over, thereby releasing the egg into surrounding water. An egg cooked in a solid cup is not poached in moving water as described in the traditional method of poaching. An egg cooked in a solid cup is instead cooked in “stagnant” water. Further, the egg may stick to the cup because of the material from which these cups are made.

In another example, eggs are cooked directly in a spoon-like device that hooks onto the side of a pan of water and has perforations on the bottom. If not hooked onto the pan's side properly or if the water level in the pan is too deep, the egg may float out of the spoon-like device and into surrounding water. If the water level is not deep enough, the egg will not be covered by the water.

### SUMMARY

In one example according to the teachings of the present invention, an egg poacher has a cup with a bottom, a side wall extending upward from a perimeter of the bottom, and an open top at a top edge of the side wall. The egg poacher has plurality of perforations formed through the side wall but not through the bottom.

In one example, a handle is connected to a part of the side wall.

In one example, the handle has a curve that is an ogee curve initiating at the connection to the side wall and terminating at a free end.

In one example, the handle extends up from the side wall and terminates at a free end and has a horizontally oriented grip.

In one example, an exterior of the grip has a non-slip characteristic.

In one example, the cup and the handle are formed of a steel alloy.

In one example, the side wall is concavely curved inward between the top edge and the bottom.

In one example, the bottom is substantially flat and has a radius at the perimeter transitioning to the side wall.

In one example, the cup has a circular cross section between the open top and the bottom.

In one example, the plurality of perforations is graduated in size with relatively smaller perforations nearer the bottom and relatively larger perforations nearer the open top.

In one example, the cup has a non-stick coating.

In one example, an egg poacher has a cup with a substantially flat bottom, a side wall extending upward from a perimeter of the bottom, and a top edge forming an open top. The cup can have a plurality of perforations formed through the side wall. The egg poacher can have a curved handle connected to a part of the side wall, extending upward above the top edge, and terminating at a free end.

In one example, the side wall is at least partly concavely curved inward between the bottom and the open top.

In one example, the bottom has a curved portion at the perimeter between the bottom and the side wall.

In one example, the perforations are arranged in an array of vertical aligned perforation sets, each set having perforations graduated in size smaller to larger toward the open top.

In one example, the handle has a tab that is generally horizontally oriented on the free end and has a grip carried thereon of a non-slip material.

In one example according to the teaching of the present invention, a method of poaching an egg includes the steps of selecting an egg poacher having a cup with a bottom, a side wall extending upward from a perimeter of the bottom, an open top, a handle connected to the side wall, and a plurality of perforations formed through the side wall, bringing a pan of water to a simmer, placing the egg poacher in the simmering water, allowing the poacher to fill with water through the perforations and to rest on a pan surface, cracking open a raw egg, placing a raw egg contents in the cup, cooking the egg for the desired period of time, grasping the handle above the level of the water, lifting the egg poacher above the level of the water, tipping the egg poacher to drain water from the cup through the perforations, and further tipping the egg poacher to release the cooked egg onto a surface.

### BRIEF DESCRIPTION OF THE DRAWINGS

Objects, features, and advantages of the present invention will become apparent upon reading the following description in conjunction with the drawing figures, in which:

FIG. 1 shows a perspective view of one example of an egg poacher according to the teachings of the present invention.

FIG. 2 shows is a front view of the egg poacher shown in FIG. 1.

FIG. 3 shows a rear view of the egg poacher shown in FIG. 1.

FIG. 4 shows a right side view of the egg poacher shown in FIG. 1.

FIG. 5 shows a top view of the egg poacher shown in FIG. 1.

FIG. 6 shows a bottom view of the egg poacher shown in FIG. 1.

FIG. 7 shows a plurality of the egg poachers shown in FIG. 1 and in use in a pan.

FIG. 8 shows the egg poachers shown in FIG. 7 and the pan filled with simmering water and an egg in each egg poacher.

FIG. 9 shows one of the egg poachers shown in FIG. 8 during the process of draining water from the egg poacher after cooking the egg.

FIG. 10 shows the egg poacher shown in FIG. 9 before the cooked egg is released to a serving dish.

FIG. 11 shows the egg poacher shown in FIG. 10 after the cooked egg is released onto the serving dish.

### DETAILED DESCRIPTION OF THE DISCLOSURE

The disclosed egg poacher and method of poaching are described and depicted as a device that solves or improves upon one or more of the above-noted or other problems and/or disadvantages with prior art egg poaching devices and methods. An egg poacher is disclosed that allows an egg to cook by a true poaching method, that aids in holding the egg together and coagulating the egg white while cooking, and that allows for easy removal of the poached egg from the cooking water and the poacher. The disclosed egg poacher simplifies and improves upon traditional methods of poaching eggs.

The disclosed egg poacher has a cup with an open top and a handle connected to the cup. The disclosed egg poacher allows an egg to cook freely in simmering water and aids in keeping the egg white from spreading or breaking up in the cooking water. Further, the egg poacher aids in the easy removal of a poached egg from the cooking water. In one example, the disclosed egg poacher has a handle to facilitate easy grasping and transport of the egg poacher to and from a pan of cooking water. The disclosed egg poacher can be used in different combinations of multiple egg poachers within a single cooking pan. The disclosed egg poacher also has a substantially flat bottom that can sit on the bottom surface of the cooking pan full of water without the egg poacher tending to float.

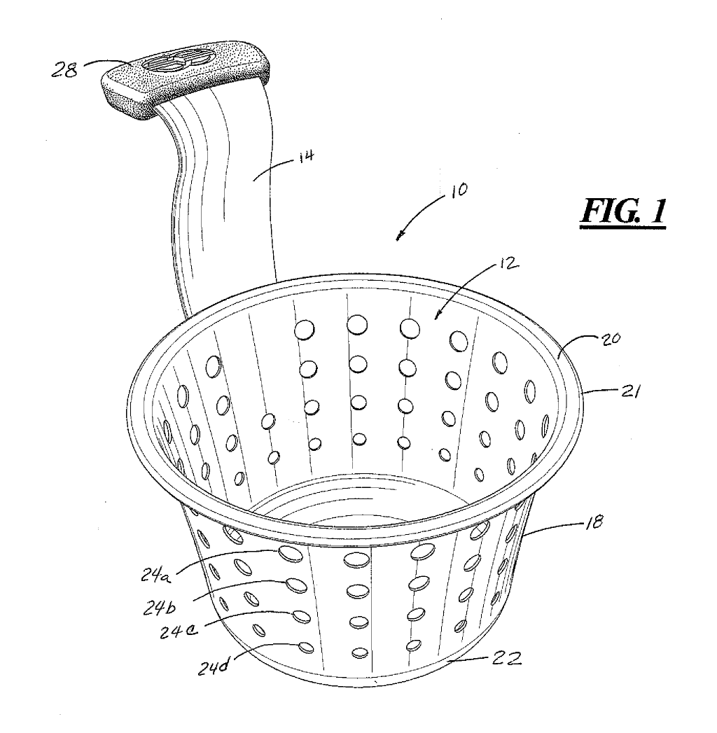

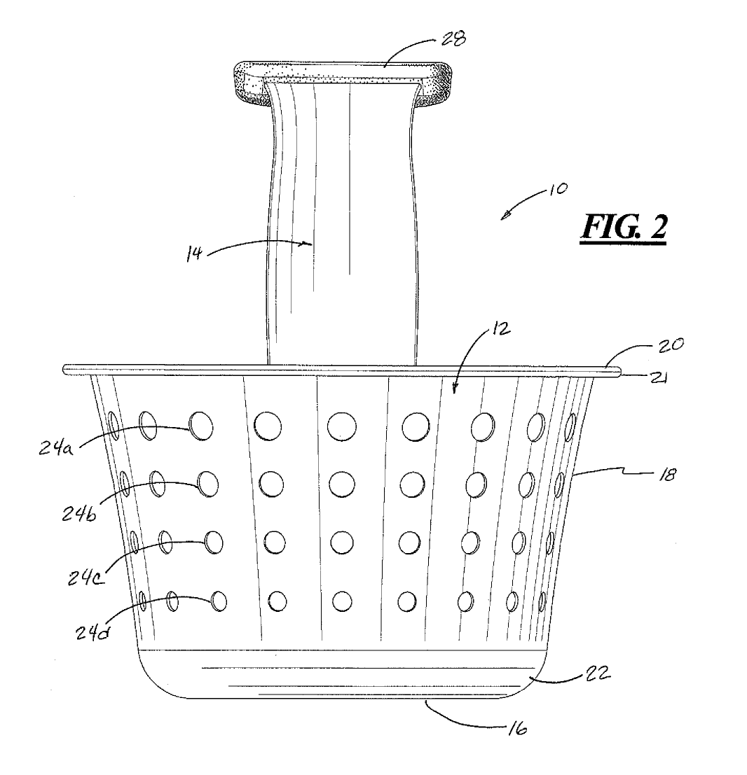

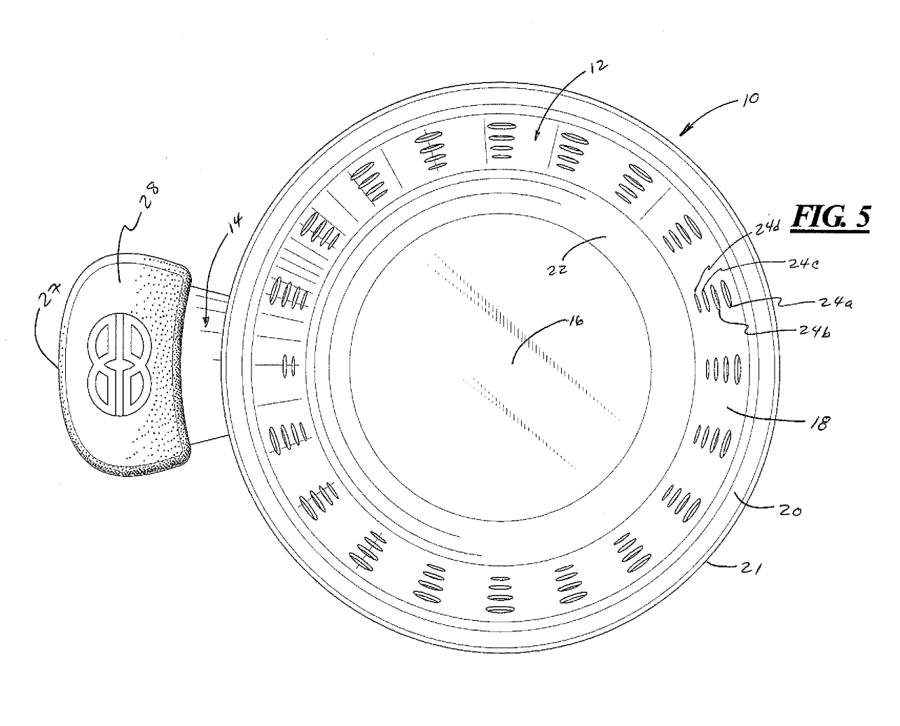

Turning now to the drawings, FIG. 1 shows one example of an egg poacher 10 according to the teachings of the present invention. The egg poacher 10 has a cup 12 and a handle 14. The handle 14 is curved and extends upward from the cup 12. As shown in FIG. 5, the cup has a circular cross section when viewed from the top. An upper edge 20 of the side wall can include a flat rim 21 as shown in FIGS. 2-4.

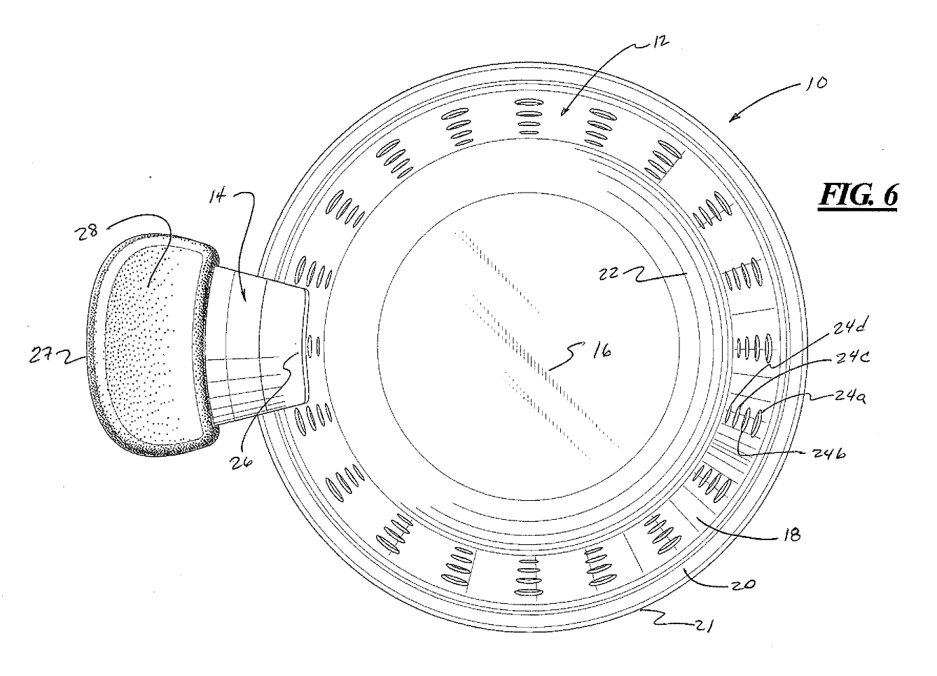

With reference to FIGS. 1-6, the cup 12 in one example has a flat bottom 16 and a side wall 18 that extends generally vertically upward though tapered outward. A curved transition 22 connects the side wall 18 to a perimeter of the bottom 16. The side wall 18 terminates at an upper edge 20. The curved transition 22 has a relatively small radius. The side wall 18 has a tapered profile that tapers outward toward the upper edge 20 and that is concavely curved inward between the transition 22 and the upper edge. The side wall and the bottom can be integrally formed of the same material.

Further, the side wall 18 has a plurality of perforations 24a-d arranged in a pattern of vertical columns or arrays. The bottom 16 has no perforations. The perforations 24a-d in this example are graduated in size. The largest of the perforations 24a are topmost and nearest the upper edge 20 of the side wall 18. The smallest of the perforations 24d are positioned just above the curved transition 22. The perforations 24a-d in this example become progressively smaller from top to bottom in each array or column. In the present example, each vertical column includes four of the perforations 24a-d.

Details of the cup 12 can vary from the example shown and described herein. For example, the upper edge 20 can include a rolled edge, lip, rim, or some variation thereof as is known in the art. The cross section of the cup 12 need not be circular but can be oval or another suitable shape. The number, size, and arrangement of the perforations 24a-d can vary and remain within the teachings of the present invention. The concave curve of the side wall 18 can also vary and remain within the teachings of the present disclosure. The taper angle of the side wall 18 can also vary as the wall narrows from the upper edge 20 to the bottom 16. Alternatively, the side wall 18 can have a straight profile with no concave curve and/or can have no side wall taper and remain within the teachings of the present invention. The bottom 16 of the cup 12 can have surface features such as dimples, recesses, or protruding rings, or the like, that result in a non-flat bottom but define a plane on which the egg poacher 10 can rest. Alternatively, the bottom 16 can have a slight concave or convex curve and still rest on a surface.

The materials of the egg poacher 10 can vary. The cup 12 can be made of a material suitable for use in cookware such as a steel alloy, aluminum, copper, stainless steel, a metal laminate, or a non-metal material. The egg poacher 10 may have a non-stick surface coating on an interior surface or on the entire cup 12.

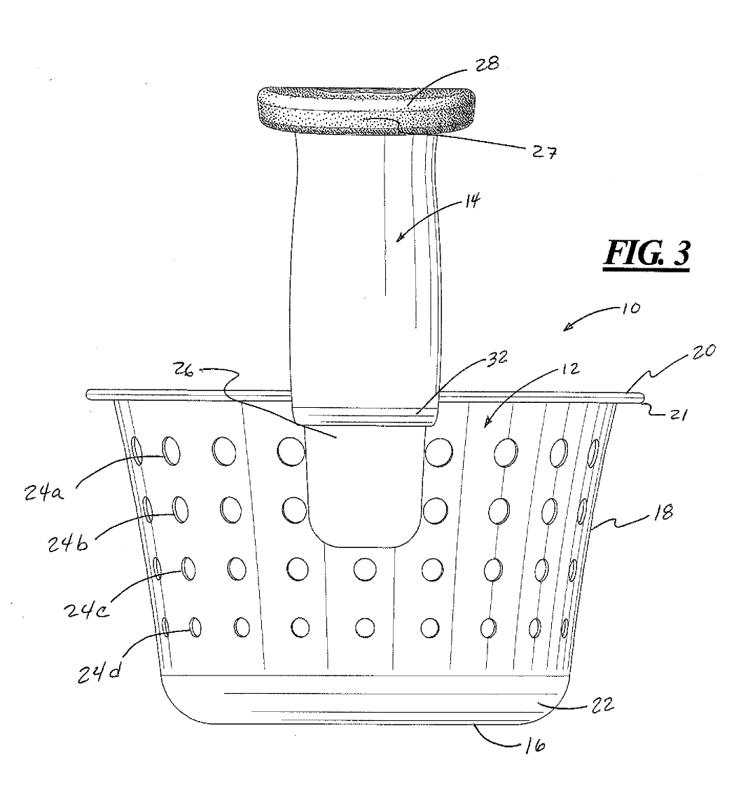

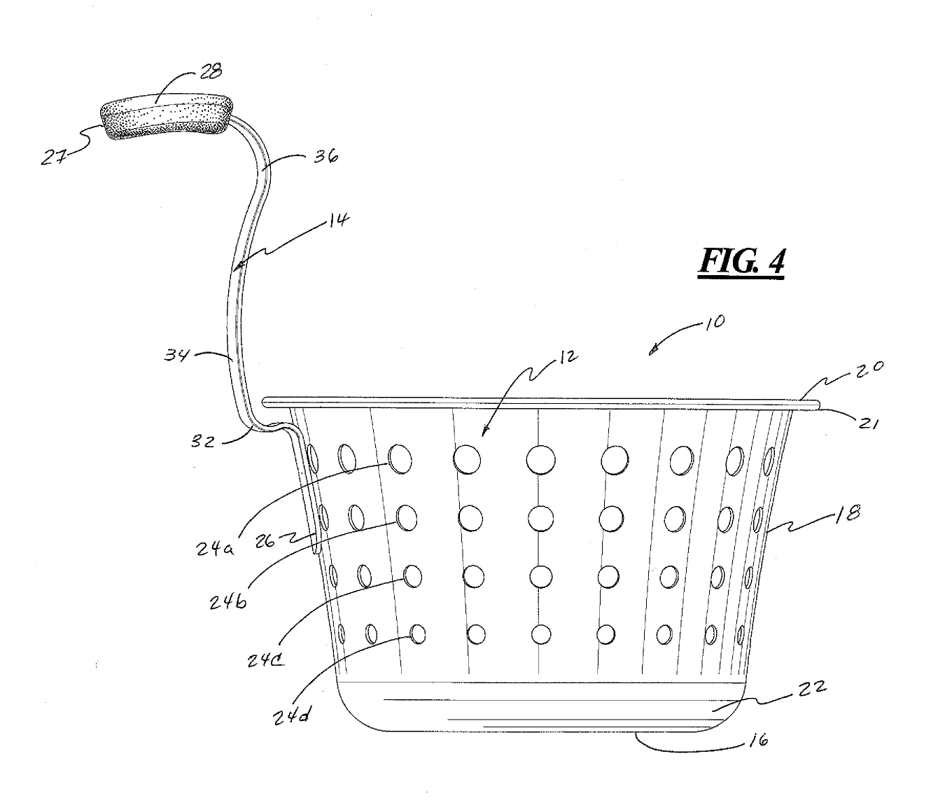

A shown in FIGS. 3 and 4, the handle 14 has a proximal end 26 that is attached to the side wall 18 of the egg poacher 10. The proximal end 26 attaches to an outer surface of a part of the side wall 18. The shape of the proximal end 26 matches the shape and contour of the side wall to allow the proximal end 26 to fully contact and attach securely to the side wall.

As FIGS. 3 and 4 show, the handle 14 is curved and has a first small radius curve 32 that is bent outwardly around the upper edge 22 of the side wall 18 and above the proximal end 26. The handle 14 extends further upward in a second convex curve 34 and continues upward and transitions to another small concave curve 36. The compound curves 34, 36 generally give the handle a profile of an ogee curve.

The handle 14 has a grip 28 at the upper end. The distal or free end 27 of the handle 14 extends radially outward and generally horizontally from the small concave curve 36. The handle 14 is relatively elongate. A grip 28 is attached to the free end 27 of the handle 14 and is generally sized to accommodate being grasped between a thumb and forefinger of a user. The grip 28 can have a molded element adhered or attached to the distal or free end 27 and can envelop the handle base material. The grip 28 can be removable and can be made of a non-slip, non-heat conducting material such as rubber, silicone, or plastic. Such a material may eliminate the need to use a pot holder for grasping and holding the egg poacher 10 during use. If a pot holder were necessary, it could accidentally drag in hot cooking water when reaching for and grasping the egg poacher.

The handle 14 can be made of the same material as the cup 12 or a different but compatible material such as a steel alloy, aluminum, brass, or the like. The handle can be welded, riveted, or otherwise attached to the cup in a sturdy manner.

The egg poacher 10 may be manufactured using a number of different processes. The cups may be made individually through a stamping or deep drawing process. The perforations may be made by a secondary process such as a punch press operation before the cup is formed.

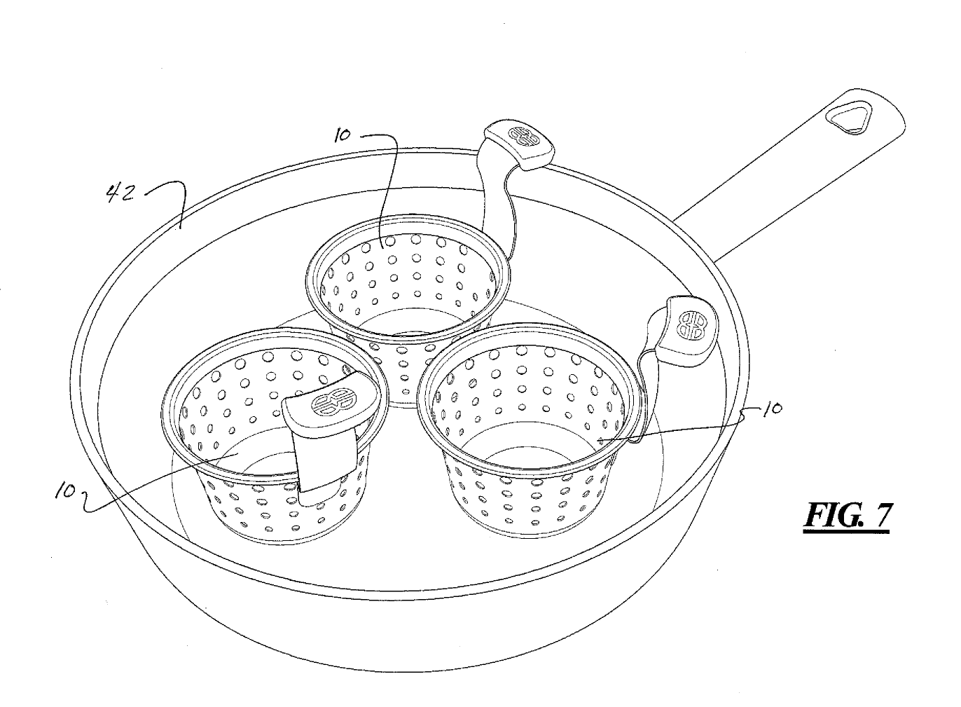

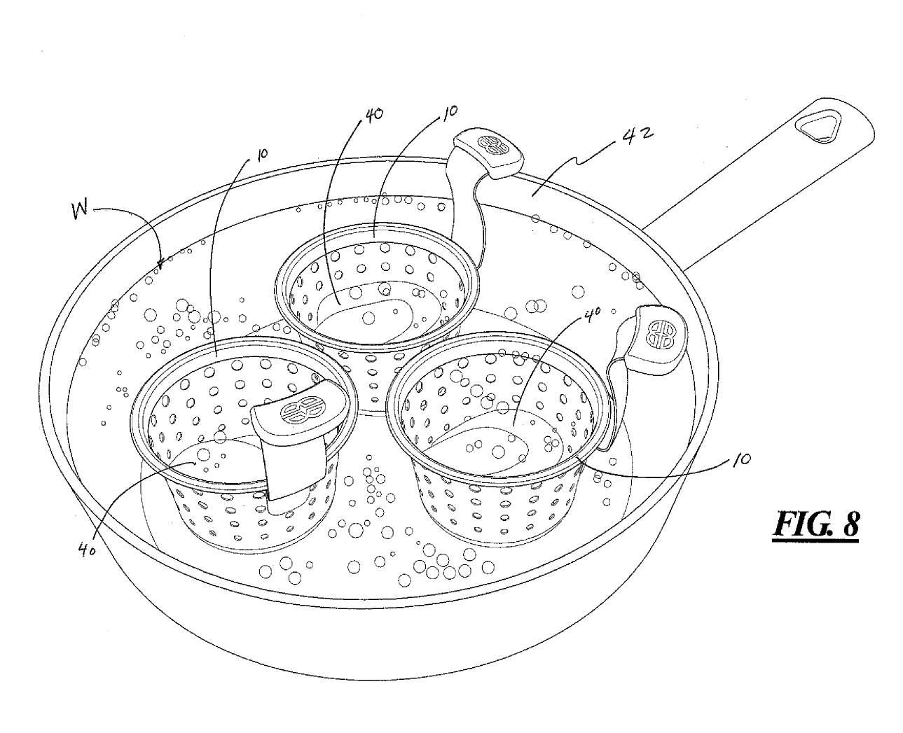

The method of poaching an egg using the above described egg poacher 10 involves the following steps. Once a cook decides on the number of eggs to be poached at a time, typically between one and four, the cook selects an egg poacher 10 for each egg. Three egg poachers 10 are shown in FIG. 7 for poaching three eggs 40 in a pan 42. The cook selects the pan 42 having a sufficient diameter to accommodate the selected number of egg poachers 10. The pan 42 is filled with water W as shown in FIG. 8 to a depth that is below the upper edge 20 of the cup 12 of the egg poacher 10, but high enough to cover some of the perforations 24a-d. The pan 42 of water W is first brought to a boil. The temperature is then reduced to a simmer, generally 160° to 180° F. (71° to 82° C.). A dash of white vinegar may be added to the water W to aid in coagulating the eggs 40 as is sometimes done in the traditional method of poaching.

The following steps will be discussed in the singular with each of the steps being repeatable if multiple eggs are being poached, such as in FIGS. 7-9. The egg poacher 10 is placed in the simmering water W. Water quickly flows into the cup 12 through the perforations 24a-d in the side wall 18. The cup 12 fills to the level of the water in the pan 42. The cup 12 becomes stable, does not tip over, and is prevented from floating in the simmering water W. The substantially flat bottom 16 of the cup 12 rests on the bottom surface of the pan of water. A raw egg is cracked, often first into a small dish, then the egg 40 is gently placed to float in the water W within the egg poacher 10 as shown in FIG. 8. The cup 12 sits submerged in the simmering water bath. The perforations 24a-d allow water W to percolate through the cup 12 to gently “toss” the egg 40. The relatively smaller perforations 24a-d in the lower portion of the side wall 18 aid in containing the egg white within the egg poacher 10. Hot water W works its way all around the cooking egg 40 thereby helping to prevent the egg from sticking to the egg poacher 10. If the egg poacher 10 has a non-stick coating, such coating will also help prevent the egg 40 from sticking to it. The egg 40 is cooked for the desired period of time. At about 4 minutes for a typical poached egg 40, the white is set, yet the yolk is still soft to the touch.

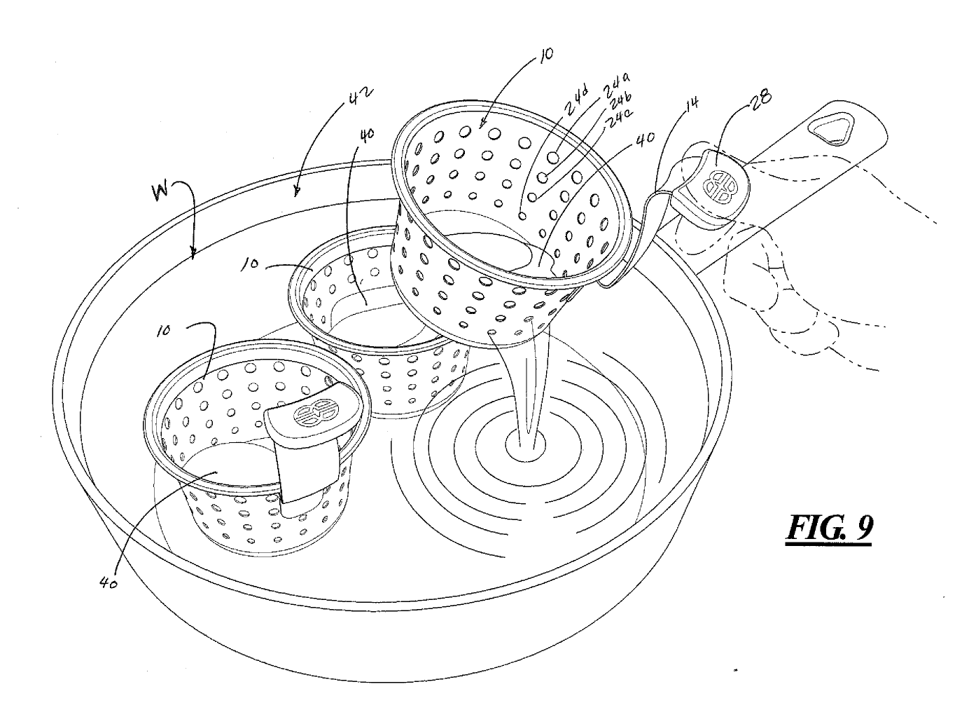

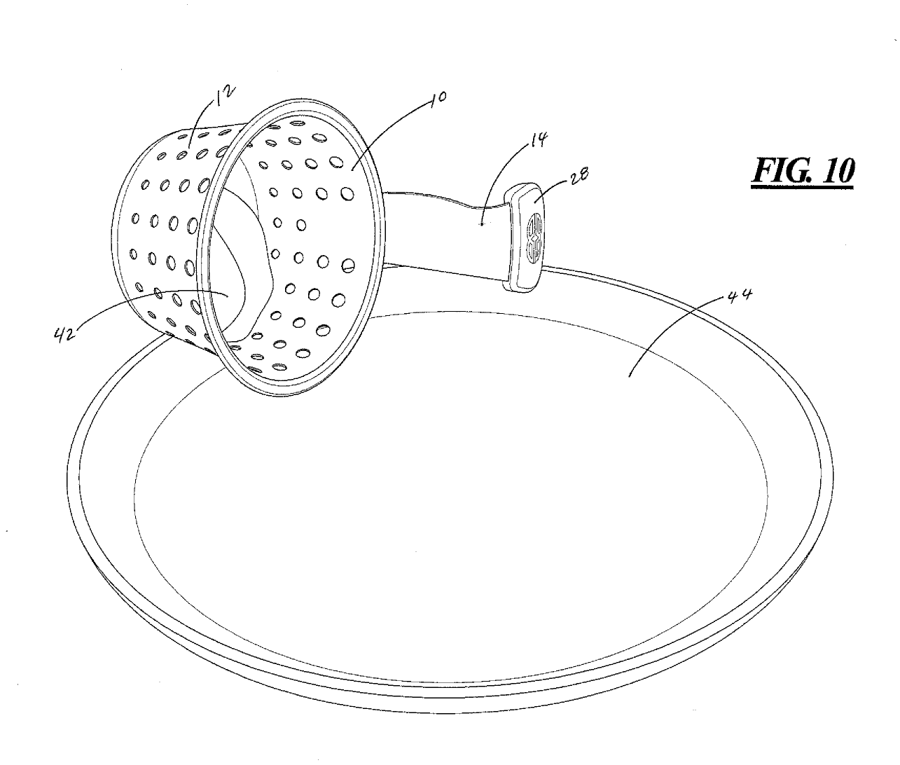

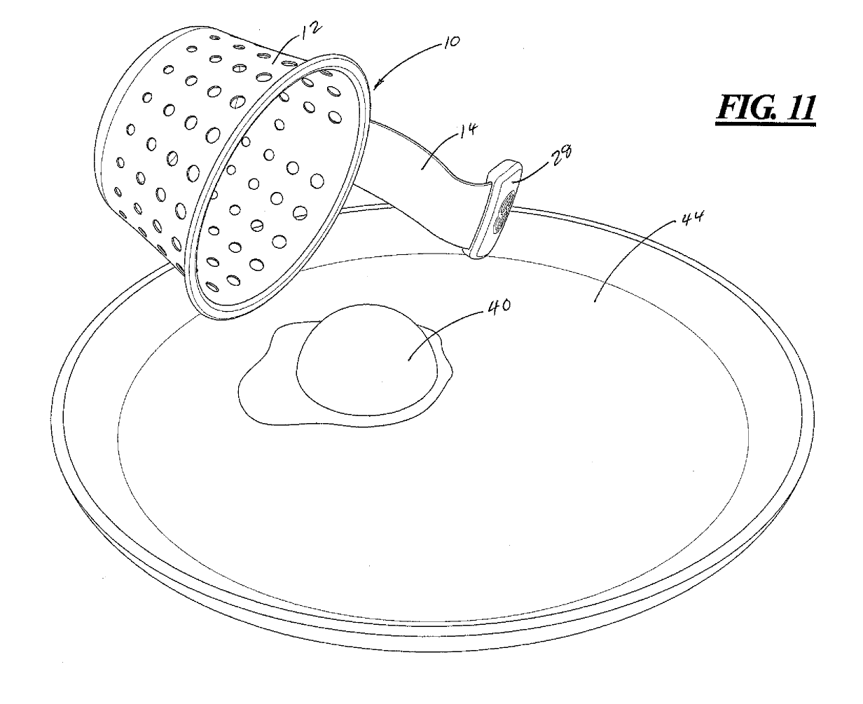

To remove the poached egg 40 from the simmering water W, a cook grasps the grip 28 of the handle 14. The egg poacher 10 containing the cooked egg 40 is lifted above the level of the water W as shown in FIG. 9. While holding the egg poacher 10 over the pan 42 of water W, the cook tilts or tips the egg poacher to an angle of less than 90°, but sufficient to drain water W through the perforations 24a-d through the side wall 18 without releasing the cooked egg 40. In this way the cooked egg 40 is separated from the water W. The poacher 10 is then lifted and moved to a position over a serving dish 44 as shown in FIG. 10. The egg poacher 10 is again tilted or tipped but to a greater angle of closer to 90° more than 90° and the egg 40 gently slips from the egg poacher 10 to the serving dish 44 as shown in FIG. 11.

Methods of poaching an egg can vary depending on cooking techniques and characteristics of poachers and remain within the teachings of the present invention. The size and depth of the cooking pan can vary. The cooking time, substitution of milk for water, precise simmering temperature, and the like can vary depending on individual tastes.

When poaching an egg according to the method described herein, the tip angles to drain the water and to release the egg can vary, depending on the locations and numbers of perforations, the curvature of the side wall, the wall taper angle, and the like.

Although certain egg poachers have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. An egg poacher comprising:
a cup having a bottom, a side wall extending upward from a perimeter of the bottom, and an open top at a top edge of the side wall; and
a plurality of perforations formed through the side wall but not through the bottom.

2. An egg poacher according to claim 1, further including a handle connected to a part of the side wall.

3. An egg poacher according to claim 2, wherein the handle has a curve that is an ogee curve initiating at the connection to the side wall and terminating at a free end.

4. An egg poacher according to claim 2, wherein the handle extends up from the side wall and terminates at a free end, the handle having a horizontally oriented grip.

5. An egg poacher according to claim 4, wherein an exterior of the grip has a non-slip characteristic.

6. An egg poacher according to claim 2, wherein the cup and the handle are formed of a steel alloy.

7. An egg poacher according to claim 1, wherein the side wall is concavely curved inward between the top edge and the bottom.

8. An egg poacher according to claim 1, wherein the bottom is substantially flat and has a radius at the perimeter transitioning to the side wall.

9. An egg poacher according to claim 1, wherein the cup has a circular cross section between the open top and the bottom.

10. An egg poacher according to claim 1, wherein the plurality of perforations is graduated in size with relatively smaller perforations nearer the bottom and relatively larger perforations nearer the open top.

11. An egg poacher according to claim 1, wherein the cup has a non-stick coating.

12. An egg poacher comprising:
a cup having a substantially flat bottom, a side wall extending upward from a perimeter of the bottom, and a top edge forming an open top;
a plurality of perforations formed through the side wall; and
a curved handle connected to a part of the side wall, extending upward above the top edge, and terminating at a free end.

13. An egg poacher according to claim 12, wherein the side wall is at least partly concavely curved inward between the bottom and the open top.

14. An egg poacher according to claim 12, wherein the bottom has a curved portion at the perimeter between the bottom and the side wall.

15. An egg poacher according to claim 12, wherein the perforations are arranged in an array of vertical aligned perforation sets, each set having perforations graduated in size smaller to larger toward the open top.

16. An egg poacher according to claim 12, wherein the handle has a grip that is generally horizontally oriented on the free end and the grip carries thereon a non-slip, non-heat conducting material.

17. A method of poaching an egg, the method comprising the steps of:
(a) selecting an egg poacher having a cup with a bottom, a side wall extending upward from a perimeter of the bottom, an open top, a handle connected to the side wall, and a plurality of perforations formed through the side wall;
(b) bringing a pan of water to a simmer;
(c) placing the egg poacher in the simmering water allowing the poacher to fill with water through the perforations and to rest on a pan surface;
(d) cracking open a raw egg;
(e) placing a raw egg contents in the cup;
(f) cooking the egg for the desired period of time;
(g) grasping the handle above the level of the water;
(h) lifting the egg poacher above the level of the water;
(i) tipping the egg poacher to drain water from the cup through the perforations without releasing the cooked egg contents until the egg is separated from the water; and
(j) further tipping the egg poacher to release the cooked egg onto a surface.
